(19) United States
(12) Patent Application Publication
(10) Pub. No.: US 2015/0032959 A1
(43) Pub. Date: Jan. 29, 2015

(54) CACHE CONTROL ON HOST MACHINES

(71) Applicant: International Business Machines Corporation, Armonk, NY (US)

(72) Inventors: Manish Gupta, New Delhi (IN); Brian James Snitzer, West Chester, PA (US)

(73) Assignee: International Business Machines Corporation, Armonk, NY (US)

(21) Appl. No.: 13/953,408

(22) Filed: Jul. 29, 2013

(51) Int. Cl. G06F 12/08; G06F 9/455

(52) U.S. Cl. CPC G06F 12/0893; G06F 9/45533
USPC 711/118

(57) ABSTRACT

An approached is provided for monitoring data from a host machine running at least one virtual machine (VM); analyzing the monitored data from the host machine; conducting inferences from the analysis to determine a preferred size of a cache; and managing the cache size based upon the inferences for adapting the cache size on the host running the at least one VM.

### TECHNICAL FIELD

The present invention relates to node/host cache control, and more specifically, to growing or shrinking the size of a cache used for caching of content that will help in construction of an image template to be used for creating a virtual machine (VM) on a host.

### BACKGROUND

Dynamically cache control can be performed by dynamically analyzing lookup requests from a cache look-up algorithm to look-up data block tags corresponding to blocks of data previously inserted into a cache memory, to determine a cache related parameter. Other cache control includes a cache on-demand module employing a cache performance module for managing size adjustments to a cache size.

### SUMMARY

According to one aspect of the present invention, a method includes monitoring data from a host machine running at least one virtual machine (VM); analyzing the monitored data from the host machine; conducting inferences from the analysis to determine a preferred size of a cache; and managing the cache size based upon the inferences for adapting the cache size on the host running the at least one VM.

According to another aspect of the present invention, a computer system including one or more processors, one or more computer-readable memories and one or more computer-readable, tangible storage devices; a data receiver operatively coupled to at least one of the one or more storage devices for execution by at least one of the one or more processors via at least one of the one or more memories, configured to monitor data from a host machine running at least one virtual machine (VM); a data analyzer operatively coupled to at least one of the one or more storage devices for execution by at least one of the one or more processors via at least one of the one or more memories, configured to analyze the monitored data from the host machine; an inference manager operatively coupled to at least one of the one or more storage devices for execution by at least one of the one or more processors via at least one of the one or more memories, configured to conduct inferences from the analysis to determine a preferred size of a cache; and an action manager operatively coupled to at least one of the one or more storage devices for execution by at least one of the one or more processors via at least one of the one or more memories, configured to manage the cache size based upon the inferences for adapting the cache size on the host running the at least one VM.

According to yet another aspect of the present invention, a computer program product includes one or more computer-readable, tangible storage medium; program instructions, stored on at least one of the one or more storage medium, to monitor data from a host machine running at least one virtual machine (VM); program instructions, stored on at least one of the one or more storage medium, to analyze the monitored data from the host machine; program instructions, stored on at least one of the one or more storage medium, to conduct inferences from the analysis to determine a preferred size of a cache; and program instructions, stored on at least one of the one or more storage medium, to manage the cache size based upon the inferences for adapting the cache size on the host running the at least one VM.

### BRIEF DESCRIPTION OF THE SEVERAL VIEWS OF THE DRAWINGS

FIG. 1 shows a storage space allocation according to an embodiment of the present invention.

FIG. 2 shows an exemplary implementation according to an embodiment of the present invention.

FIG. 3 shows another exemplary implementation according to an embodiment of the present invention.

FIG. 4 shows a flowchart according to an embodiment of the present invention.

FIG. 5 shows another flowchart according to an embodiment of the present invention.

FIG. 6 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

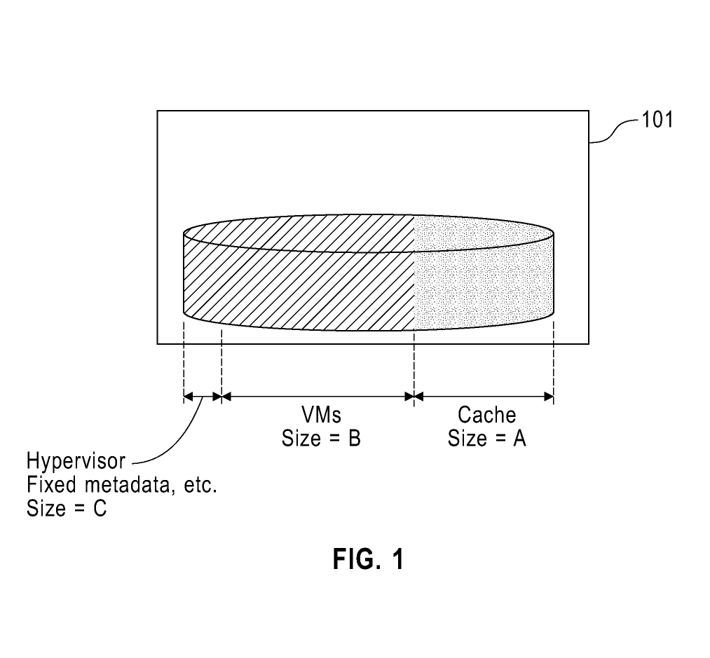

Referring to FIG. 1, shown is physical host 101 having local storage. The storage includes space for a cache A, virtual machines VMs B and a Hypervisor. The methodology according to an embodiment of the present invention uses the entire disk to cache chunks of nodes to either gradually shrink the cache as the node becomes more and more utilized or as the node becomes less utilized it increases the size of the cache. If the cache is shrunk/grown then the node contacts a Cache Analytics Engine to decide what to remove/add. Details regarding the methodology for increasing or decreasing the cache size will be explained in more detail hereafter with regards the exemplary implementations. Total storage capacity is A+B+C. A is the storage capacity available for caching of templates or chunks. B is the total storage capacity occupied by VMs. C is the storage capacity used by the hypervisor, and any other permanent software installed on the system, include the caching software's metadata. Cache A is expected to be variable with time as the requirements for the VM's storage changes.

In virtualized or cloud environments, a repository of images templates exists from which image templates are used to create a VM instance on a physical host. The image repository may also contain “chunks” of image templates from which the VM at the physical host may be composed. In any case, the chunks or the entire image template have/has to be transferred to the physical host to create the VM instance. This incurs latency, traffic on the intervening network, and clogging of the data. To reduce all the three it is proposed that a cache is created locally on the physical host which runs the VMs to host the templates/chunks.

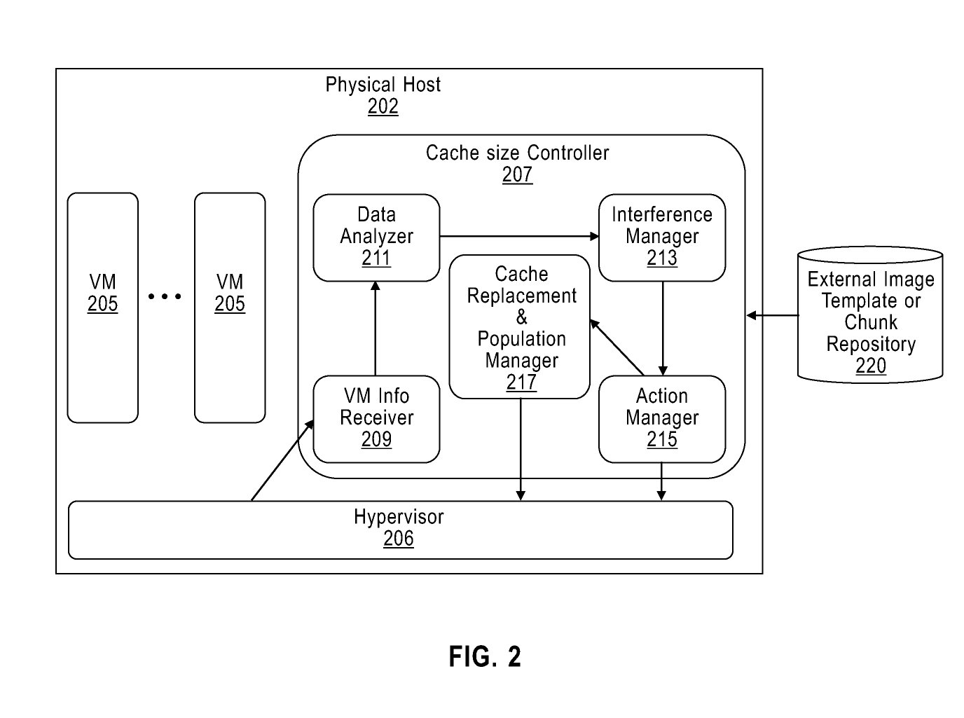

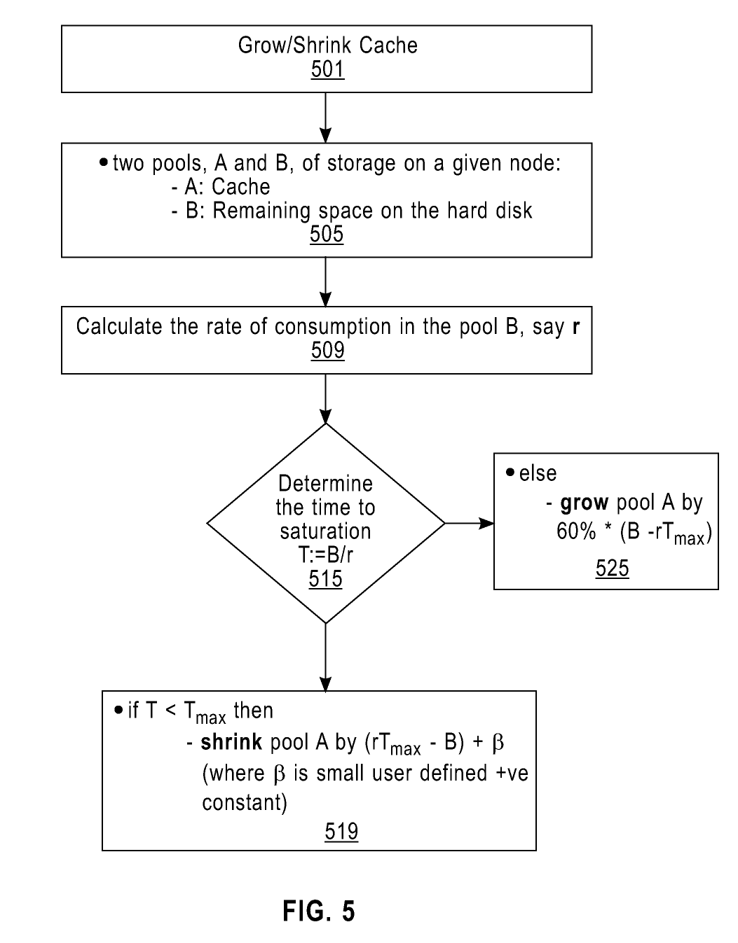

Referring to FIG. 2, a first exemplary implementation shows one configuration where a cache size controller 207 runs completely on a host 202. The host 202 also houses virtual machines 205 and a hypervisor 206. The cache size controller 207 includes a VM Info Receiver 209, a data analyzer 211, an inference manager 213, an action manager 215 and Cache Replacement and Population Manager 217. The VM Info Receiver 209 receives raw data on the creation or deletion of a VM or storage space occupied by the VMs. It could subscribe to respective events from OS/hypervisor or could poll for the information required. The data may include 1) total storage space consumed by VMs running or provisioned on the host at regular time intervals with two consecutive times A apart. Were the data points generated by the VM Info Receiver 209 can be S₁, S₂, S₃, . . . Sₙ, where as mentioned earlier each point corresponds to the storage capacity consumed by all the VMs provisioned on the host. The data analyzer 211 computes higher level statistics based on the information received from the VM Info Receiver 209. The data analyzer 211 further computes an estimate for the rate of growth of consumption of the storage space allocated to VMs 205 on the host 202. Based on the data points the estimate of growth rate at time t can be expressed by: (Sₜ−S_{t-Δ})/Δ. This is an immediate way to obtain the growth rate but smoothing methods in statistics could be applied to remove outliers. One will define the estimate of the rate of consumption as r. Inference Manager 213 determines the size of the cache—increase it or decrease it. More information on increasing or decreasing the cache size will described in more detail with reference to FIG. 5. The action manager 215 executes the decision taken by the inference manager 213 and notifies the cache replacement and population manager (CRPM) 217 which is responsible to decide what content to store in the cache.

Still referring to FIG. 2, the action manager 215 maintains two thresholds Aₘᵢₙ and Aₘₐₓ which are user defined. Aₘᵢₙ is the lower bound on the size of the cache in the sense that a size lower than Aₘᵢₙ cannot be set by the action manager 215. Similarly, the action manager 215 cannot set the size of the cache to be greater than Aₘₐₓ. By default Aₘᵢₙ=0 and Aₘₐₓ=total storage capacity—space occupied by fixed software (boot, installed software on the hypervisor, cache metadata, etc). Cache metadata includes the cache related code, and other metadata required to run the various components of the cache. The action manager 215 also notifies the hypervisor 206 regarding either increasing or decreasing the cache. In case the cache size changes then action manager 215 calls CRPM 217. If the size of cache increases then CRPM 217 contacts the Image/Chunk repository 220 to obtain appropriate chunks or image templates to store in the available space. For example, the decision on which chunk or template to include could be based on the frequency of use and size of the template—higher the product of frequency and the size higher the network load, and therefore keeping such a template or chunk in the cache (if not already there) could be beneficial. If the size of the cache decreases then CRPM 217 decides to evict those templates/chunks which for whom the product of the frequency of use and size is the least. The CRPM 217 could belong to another system or software and yet could connect with the present embodiment and function in the same manner. The cache size controller 207 may receive input from an external software that assists in deciding upon thresholds as well as the contents of the cache.

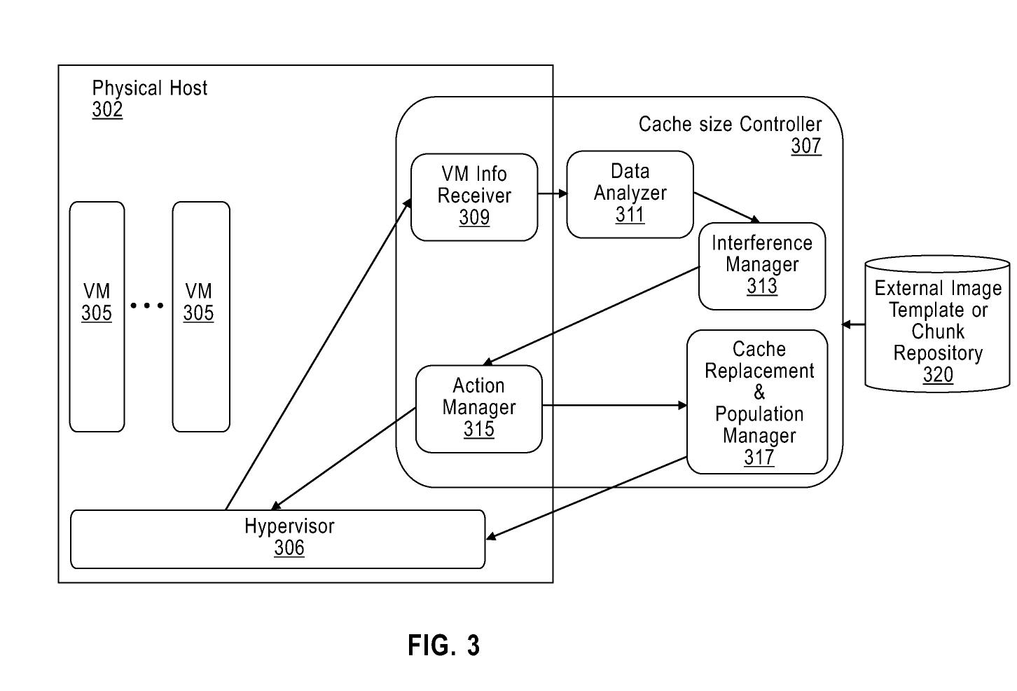

Referring to FIG. 3, another embodiment of the present invention provides for another configuration in which part or all of cache size controller 307 runs outside of the host 302. One or more of the components of the cache size controller 307 could sit outside of the physical host 302. For example the VM info receiver 309 and action manager 315 could sit inside the host 302. The rest of the components, data analyzer 311, inference manager 313, CRPM 317 may be part of other systems. This could reduce the computation overhead on the host 302. The internal and external components function in the same manner as described with reference to the internal components of FIG. 2 for the cache size controller 207. Specifically, the host 302 also houses virtual machines 305 and a hypervisor 306. If the size of cache increases then CRPM 317 contacts the Image/Chunk repository 320 to obtain appropriate chunks or image templates to store in the available space. For example, the decision on which chunk or template to include could be based on the frequency of use and size of the template—higher the product of frequency and the size higher the network load, and therefore keeping such a template or chunk in the cache (if not already there) could be beneficial. If the size of the cache decreases then CRPM 317 decides to evict those templates/chunks which for whom the product of the frequency of use and size is the least. The CRPM 317 could belong to another system or software and yet could connect with the present embodiment and function in the same manner. The cache size controller 307 may receive input from an external software that assists in deciding upon thresholds as well as the contents of the cache.

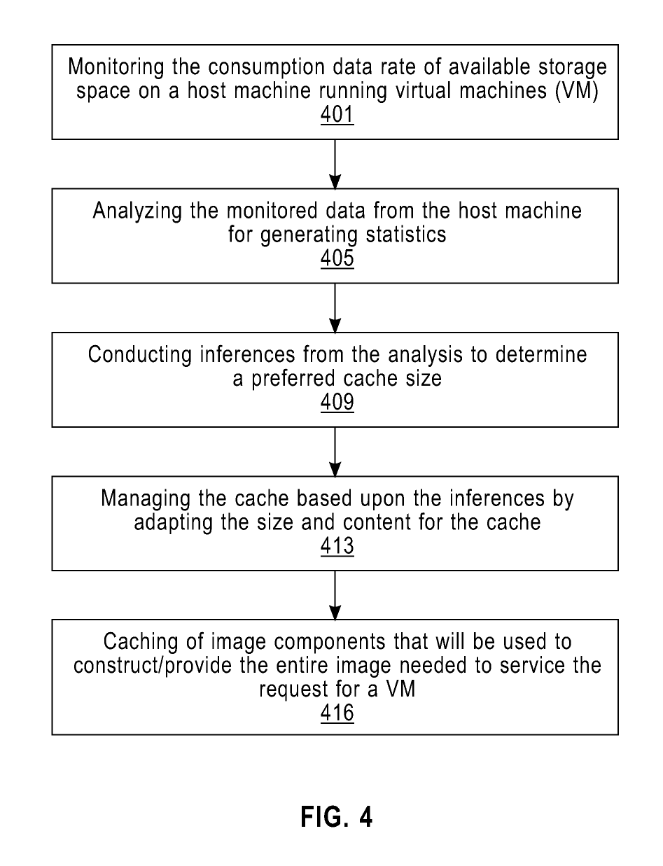

Referring to FIG. 4, a flow chart according to an embodiment of the present invention is depicted. The process includes monitoring the consumption data rate of available storage space on a host machine running virtual machine (VMs) (401). The process continues by analyzing the monitored data from the host machine for generating statistics (405). Once the analyzing of the monitored data and the generation of statistics based upon the data is complete, the process conducts inferences to determine a preferred cache size (409). The process then manages the cache based upon the inferences and adapting the size and content of the cache (413). The process concludes by caching image components that will be used to construct/provide the entire image needed to service the request for a VM (416).

Referring to FIG. 5, in order to either increase or decrease the cache size, one needs to address the storage space and its components. Let the size of the cache and of the available capacity for adding new VMs be, respectively, denoted as A and B at the time the Inference Manager runs.

To grow or shrink a cache (501) consider two pools, A and B, of storage on a given node (505):

A: Cache

B: Remaining space on the hard disk.

Using A and B to denote the instantaneous size of each pool, the rate of consumption in the pool B, say r is calculated (509). Next, the process determines the time to depletion/saturation (515) T:=B/r if T<Tₘₐₓ then

shrink pool A by (rTₘₐₓ−B)+β, where β is small user defined +ve constant (519) else

grow pool A (525) by 60%*(B−rTₘₐₓ).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

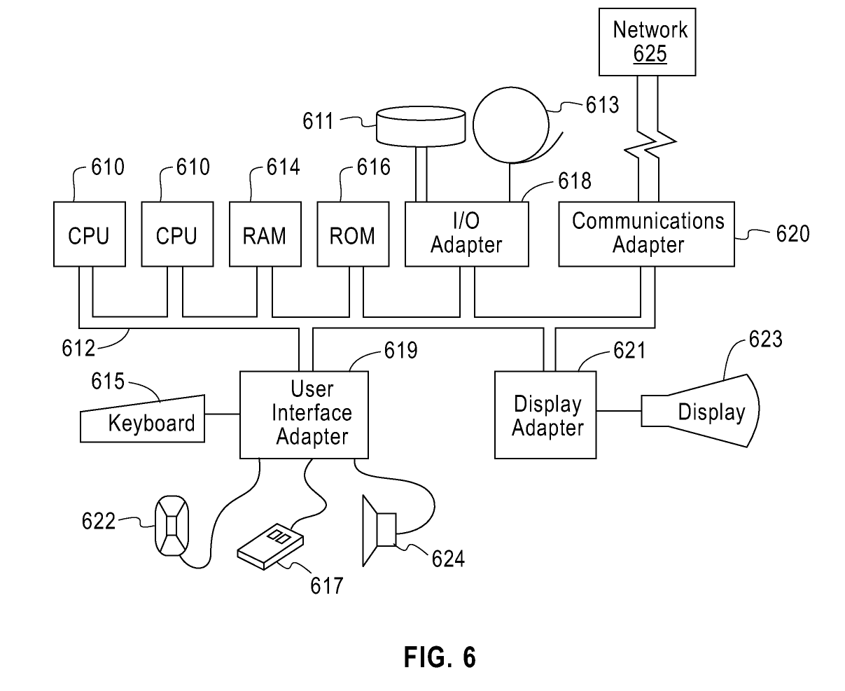

Referring now to FIG. 6, this schematic drawing illustrates a hardware configuration of an information handling/computer system in accordance with the embodiments of the invention. The system comprises at least one processor or central processing unit (CPU) 610. The CPUs 610 are interconnected via system bus 612 to various devices such as a random access memory (RAM) 614, read-only memory (ROM) 616, and an input/output (I/O) adapter 618. The I/O adapter 618 can connect to peripheral devices, such as disk units 611 and tape drives 613, or other program storage devices that are readable by the system. The system can read the inventive instructions on the program storage devices and follow these instructions to execute the methodology of the embodiments of the invention. The system further includes a user interface adapter 619 that connects a keyboard 615, mouse 617, speaker 624, microphone 622, and/or other user interface devices such as a touch screen device (not shown) to the bus 612 to gather user input. Additionally, a communication adapter 620 connects the bus 612 to a data processing network 625, and a display adapter 621 connects the bus 612 to a display device 623 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
monitoring data from a host machine running at least one virtual machine (VM);
analyzing the monitored data from the host machine;
conducting inferences from the analysis to determine a preferred size of a cache; and
managing the cache size based upon the inferences for adapting the cache size on the host running the at least one VM.

2. The method according to claim 1, wherein the monitoring of data from a host includes gathering a consumption rate of a storage space on the host by the at least one virtual machine.

3. The method according to claim 1, further comprising caching of image components to provide an entire image needed to service the request for the at least one VM.

4. The method according to claim 1, wherein the analyzing of the monitored data includes generating statistics.

5. The method according to claim 2, wherein the conducting of inferences includes computing a depletion time of the storage space based upon the consumption rate.

6. The method according to claim 5, wherein the managing of the cache size is based on the computed depletion time.

7. The method according to claim 6, wherein the cache size is decreased if the computed depletion time is below a threshold.

8. The method according to claim 6, wherein the cache size is increased if the computed depletion time is above a threshold.

9. The method according to claim 1, further comprising determining appropriate content for the cache depending on the cache size.

10. A computer system, comprising:
one or more processors, one or more computer-readable memories and one or more computer-readable, tangible storage devices;
a data receiver operatively coupled to at least one of the one or more storage devices for execution by at least one of the one or more processors via at least one of the one or more memories, configured to monitor data from a host machine running at least one virtual machine (VM);
a data analyzer operatively coupled to at least one of the one or more storage devices for execution by at least one of the one or more processors via at least one of the one or more memories, configured to analyze the monitored data from the host machine;
an inference manager operatively coupled to at least one of the one or more storage devices for execution by at least one of the one or more processors via at least one of the one or more memories, configured to conduct inferences from the analysis to determine a preferred size of a cache; and
an action manager operatively coupled to at least one of the one or more storage devices for execution by at least one of the one or more processors via at least one of the one or more memories, configured to manage the cache size based upon the inferences for adapting the cache size on the host running the at least one VM.

11. The system according to claim 10, wherein the monitoring of data from a host includes gathering a consumption rate of a storage space on the host by the at least one virtual machine.

12. The system according to claim 10, wherein the analyzing of the monitored data includes generating statistics.

13. The system according to claim 11, wherein the conducting of inferences includes computing a depletion time of the storage space based upon the consumption rate.

14. The system according to claim 13, wherein the managing of the cache size is based on the computed depletion time.

15. The system according to claim 14, wherein the cache size is decreased if the computed depletion time is below a threshold.

16. The system according to claim 14, wherein the cache size is increased if the computed depletion time is above a threshold.

17. The system according to claim 11, further comprising determining a appropriate content for the cache depending on the cache size.

18. A computer program product comprising:
one or more computer-readable, tangible storage medium;
program instructions, stored on at least one of the one or more storage mediums, to monitor data from a host machine running at least one virtual machine (VM);
program instructions, stored on at least one of the one or more storage mediums, to analyze the monitored data from the host machine;
program instructions, stored on at least one of the one or more storage mediums, to conduct inferences from the analysis to determine a preferred size of a cache; and
program instructions, stored on at least one of the one or more storage mediums, to manage the cache size based upon the inferences for adapting the cache size on the host running the at least one VM.

19. The computer program product according to claim 18, wherein the monitoring of data from a host includes gathering a consumption rate of a storage space on the host by the at least one virtual machine.

20. The computer program product according to claim 19, wherein the conducting of inferences includes computing a depletion time of the storage space based upon the consumption rate.

21. The computer program product according to claim 20, wherein the managing of the cache size is based on the computed depletion time.
